(19) United States
(12) Patent Application Publication
(10) Pub. No.: US 2024/0204304 A1
(43) Pub. Date: Jun. 20, 2024

(54) SOLID OXIDE CELL AND SOLID OXIDE CELL STACK

(71) Applicant: SAMSUNG ELECTRO-MECHANICS CO., LTD., Suwon-si (KR)

(72) Inventors: Bon Seok KOO, Suwon-si (KR); Jeong Suong YANG, Suwon-si (KR); A Reum JUN, Suwon-si (KR); Hyeg Soon AN, Suwon-si (KR); Su Beom PARK, Suwon-si (KR); Jung Hyun LEE, Suwon-si (KR)

(73) Assignee: SAMSUNG ELECTRO-MECHANICS CO., LTD., Suwon-si (KR)

(21) Appl. No.: 18/224,712

(22) Filed: Jul. 21, 2023

(30) Foreign Application Priority Data
Dec. 16, 2022 (KR) 10-2022-0176992
Jan. 31, 2023 (KR) 10-2023-0012922

(51) Int. Cl. H01M 12/06; H01M 50/183

(52) U.S. Cl. CPC H01M 12/06; H01M 50/183; H01M 2300/0071

(57) ABSTRACT

A solid oxide cell includes a fuel electrode, an electrolyte including a base portion disposed on the fuel electrode, a dam portion disposed on the base portion, and a recess portion surrounded by the dam portion, and an air electrode disposed in the recess portion of the electrolyte, wherein a region in which the fuel electrode and the electrolyte overlap each other in a thickness direction of the electrolyte is greater than or equal to a region in which the air electrode and the electrolyte overlap each other.

### CROSS-REFERENCE TO RELATED APPLICATION (S)

This application claims benefit of priority to Korean Patent Application No. 10-2022-0176992 and 10-2023-0012922 filed on Dec. 16, 2022, and Jan. 31, 2023, in the Korean Intellectual Property Office, the disclosures of which are incorporated herein by reference in its entirety.

### TECHNICAL FIELD

The present disclosure relates to a solid oxide cell and a solid oxide cell stack.

A solid oxide fuel cell (SOFC) and a solid oxide electrolysis cell (SOEC) include a cell composed of a solid electrolyte having an air electrode, a fuel electrode, and oxygen ion conductivity, and the cell may be referred to as a solid oxide cell. A solid oxide cell produces electric energy by electrochemical reactions, or produces hydrogen by electrolyzing water by reverse reactions of the solid oxide fuel cell. The solid oxide cell has low overvoltage based on low activation polarization and has high efficiency due to low irreversible loss as compared to other types of fuel cells or water electrolysis cells, such as a phosphoric acid fuel cell (PAFC), an alkaline fuel cell (AFC), a polymer electrolyte fuel cell (PEMFC), a direct methanol fuel cell (DMFC). Furthermore, because the solid oxide cell may not only be used not only for a hydrogen fuel but also for a carbon or hydrocarbon fuel, it can have a wide range of fuel choices, and because the solid oxide cell has a high reaction rate in an electrode, it does not require an expensive precious metal as an electrode catalyst.

When actually implementing a device such as a fuel cell and a water electrolysis cell, a stack structure in which interconnects and solid oxide cells are stacked on each other has been widely used. In a process of assembling the stack structure of a solid oxide cell or operating the device, pressure may be applied to the solid oxide cell, which may cause cracks or damage to the solid oxide cell.

One of the purposes of the present disclosure is to implement a solid oxide cell with excellent durability and a solid oxide cell stack using the same.

### SUMMARY

An aspect of the present disclosure is to implement a solid oxide cell with excellent durability and a solid oxide cell stack using the same.

In order to solve the above-described issues, according to an aspect of the present disclosure, a solid oxide cell includes: a fuel electrode, an electrolyte including a base portion disposed on the fuel electrode, a dam portion disposed on the base portion, and a recess portion surrounded by the dam portion, and an air electrode disposed in the recess portion of the electrolyte, wherein a region in which the fuel electrode and the electrolyte overlap each other in a thickness direction of the electrolyte is greater than or equal to a region in which the air electrode and the electrolyte overlap each other.

According to some example embodiments of the present disclosure, the air electrode may be spaced apart from the dam portion.

According to some example embodiments of the present disclosure, the base portion and the dam portion may form an integral structure.

According to some example embodiments of the present disclosure, the base portion and the dam portion may include different materials.

According to some example embodiments of the present disclosure, the base portion may include 8 mol % yttria-stabilized zirconia (8YSZ), and the dam portion may include 3 mol % yttria-stabilized zirconia (3YSZ).

According to an example embodiment of the present disclosure, the base portion may include a Yttria stabilized zirconia-based (YSZ-based) ion conductor, and the dam portion may include alumina.

According to some example embodiments of the present disclosure, the fuel electrode and the air electrode may have substantially the same width.

According to some example embodiments of the present disclosure, the fuel electrode may be wider than the air electrode.

According to some example embodiments of the present disclosure, the fuel electrode and the electrolyte may have substantially the same width.

According to some example embodiments of the present disclosure, a thickness of the dam portion may be less than or equal to a thickness of the air electrode.

According to another aspect of the present disclosure, a solid oxide cell stack includes: first and second interconnects, and a solid oxide cell disposed between the first and second interconnects, wherein the solid oxide cell includes: a fuel electrode, an electrolyte including a base portion disposed on the fuel electrode, a dam portion disposed on the base portion, and a recess portion surrounded by the dam portion, and an air electrode disposed in the recess portion of the electrolyte, wherein a region in which the fuel electrode and the electrolyte overlap each other in a thickness direction of the electrolyte is greater than or equal to a region in which the air electrode and the electrolyte overlap each other.

According to some example embodiments of the present disclosure, the solid oxide cell stack may further include a sealing material disposed outside of the solid oxide cell between the first and second interconnects.

According to an example embodiment of the present disclosure, the sealing material may be in contact with the dam portion.

According to some example embodiments of the present disclosure, the sealing material may be in contact with an upper surface and an external side surface of the dam portion.

According to some example embodiments of the present disclosure, the sealing material may be in contact with the upper surface, the external side surface, and an internal side surface of the dam portion.

According to some example embodiments of the present disclosure, the air electrode may be spaced apart from the sealing material.

In the case of a solid oxide cell according to some example embodiments of the present disclosure, when the solid oxide cell is implemented in a stack structure, durability thereof may be improved. Therefore, the solid oxide cell may be used as a fuel cell or a water electrolysis cell, thereby improving performance thereof.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is an exploded perspective view schematically illustrating a solid oxide cell according to an example embodiment of the present disclosure;

FIG. 2 is a cross-sectional view of one region of the solid oxide cell;

FIG. 3 is an enlarged view of a region of a fuel electrode;

FIG. 4 is an enlarged view of a region of an electrolyte;

FIG. 5 is an enlarged view of a region of an air electrode;

FIG. 6 is a view illustrating an example of forming a dam portion of the electrolyte;

FIG. 7 is a view illustrating an example of forming the dam portion of the electrolyte;

FIG. 8 is a cross-sectional view of a region of the solid oxide cell in a modified example;

FIG. 9 is a cross-sectional view of a region of the solid oxide cell in a modified example;

FIG. 10 is a cross-sectional view schematically illustrating a solid oxide cell stack; and

FIG. 11 is a cross-sectional view schematically illustrating the solid oxide cell stack.

### DETAILED DESCRIPTION

Hereinafter, example embodiments of the present disclosure will be described with reference to specific example embodiments and the attached drawings. The example embodiments of the present disclosure may, however, be exemplified in many different forms and should not be construed as being limited to the specific embodiments set forth herein. The example embodiments disclosed herein are provided for those skilled in the art to better explain the present disclosure. In the drawings, the shapes and dimensions of elements may be exaggerated for clarity, and the same reference numerals will be used throughout to designate the same or like elements.

In order to clearly explain the present disclosure in the drawings, the contents unrelated to the description are omitted, thicknesses of each component are enlarged to clearly express multiple layers and regions, and components with the same function within the same range of ideas are described using the same reference numerals. Throughout the specification, when a certain portion “includes” or “comprises” a certain component, this indicates that other components are not excluded and may be further included unless otherwise noted.

The term “substantially the same width” as used herein means that the width may have a difference of several percent (e.g. 5% or less).

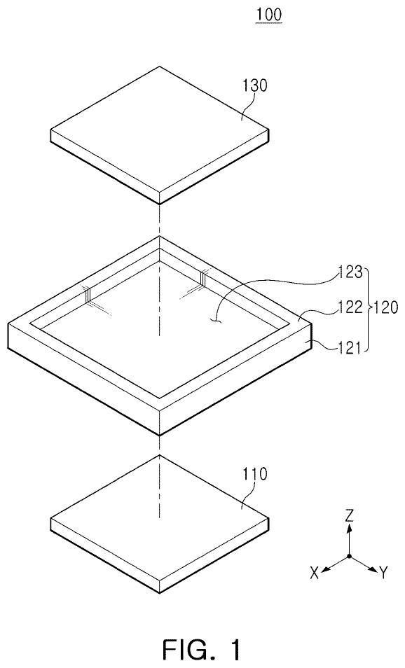

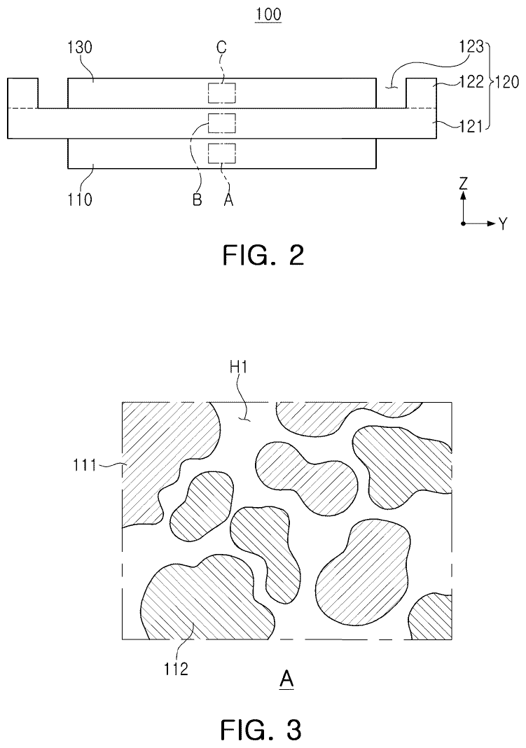

FIG. 1 is an exploded perspective view schematically illustrating a solid oxide cell according to an example embodiment of the present disclosure. FIG. 2 is a cross-sectional view of one region of the solid oxide cell. Furthermore, FIGS. 3 to 5 are enlarged views of a region of a fuel electrode, a region of an electrolyte, and a region of the air electrode.

Referring to FIGS. 1 and 2, a solid oxide cell 100 according to an example embodiment of the present disclosure includes a fuel electrode 110, an electrolyte 120, and an air electrode 130, and the electrolyte 120 includes a base portion 121, a dam portion 122, and a recess portion 123. Furthermore, a region in which the fuel electrode 110 and the electrolyte 120 overlap each other in a thickness direction of the electrolyte 120 is greater than or equal to a region in which the air electrode 130 and the electrolyte 120 overlap each other. As the electrolyte 120 includes the dam portion 122 and the air electrode 130 is disposed in the recess portion 123 of the electrolyte 120, the air electrode 130 may be effectively protected, thereby significantly reducing the possibility of crack generation and damage of the air electrode 130. Furthermore, as will be described below, the solid oxide cell 100 may be applied in a stack structure, thereby dispersing pressure which may be exerted on the fuel electrode 110 and the air electrode 130, as well as improving the airtightness of the solid oxide cell 100. Furthermore, these advantages may greatly contribute to the improvement of the characteristics of the solid oxide cell 100. Hereinafter, the components of the solid oxide cell 100 are specifically described, and a case in which the solid oxide cell 100 is used as a fuel cell is mainly described. However, the solid oxide cell 100 may also be used as a water electrolysis cell, a reaction opposite to the case of the fuel cell will occur in the fuel electrode 110 and the air electrode 130 of the solid oxide cell 100.

Specifically, when the solid oxide cell 100 is used as the fuel cell, for example, water production due to hydrogen oxidation or an oxidation reaction of a carbon compound may occur in the fuel electrode 110, and an oxygen ion generation reaction may occur due to oxygen decomposition in the air electrode 130. When the solid oxide cell 100 is used as the water electrolytic cell, a reaction opposite thereto may occur, for example, hydrogen gas may be generated by a reduction reaction of water in the fuel electrode 110, and oxygen may be generated in the air electrode 130. Furthermore, in the case of the fuel cell, a hydrogen decomposition (hydrogen ion generation) reaction may occur in the fuel electrode 110, and oxygen and hydrogen ions may be combined to generate water in the air electrode 130, and in the case of the water electrolytic cell, a water decomposition (hydrogen and oxygen ion generation) reaction may occur in the fuel electrode 110, and oxygen may be generated in the air electrode 130. Furthermore, in the electrolyte 120, ions may move to the fuel electrode 110 or the air electrode 130.

Specific structures or materials of the fuel electrode 110, the electrolyte 120, and the air electrode 130 will be described. First of all, referring to FIG. 3, the fuel electrode 110 may include an electron conductor 111 and an ion conductor 112, which may be a sintered body of particles. Furthermore, pores H1 may be formed in the fuel electrode 110, through which gas, fluid, and the like, may enter and exit. The electronic conductor 111 may include a metal catalyst such as nickel (Ni), cobalt (Co), copper (Cu), or alloys thereof, where the metal catalyst may be in a metal state or an oxide state. The ion conductor 112 of the fuel electrode 110 may include a ceramic phase, where the ceramic phase may include gadolinia doped ceria (GDC), samaria doped ceria (SDC), ytterbia doped ceria (YDC), scandia stabilized zirconia (SSZ), and ytterbia scandia stabilized zirconia (YbCSSZ).

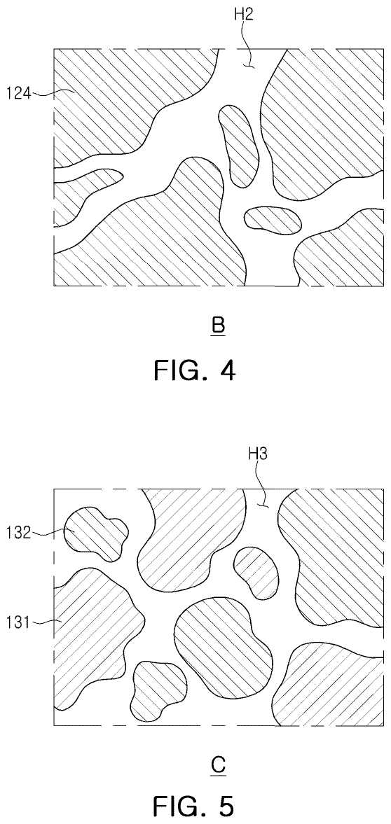

The electrolyte 120 is disposed on the fuel electrode 110. As an example of a material constituting the electrolyte 120, referring to FIG. 4, the electrolyte 120 may include an ion conductor 124, and pores H2 may be formed in the electrolyte 120, through which gas, fluid, and the like may enter and exit. The ion conductor 124 may include stabilized zirconia. Specifically, the ion conductor 124 of the electrolyte 120 may include scandia stabilized zirconia (SSZ), yttria stabilized zirconia (YSZ), scandia ceria stabilized zirconia (SCSZ), scandia ceria yttria stabilized zirconia (SCYSZ), or scandia ceria ytterbia stabilized zirconia (SCYbSZ).

Referring to FIG. 5, the air electrode 130 may include an electron conductor 131 and an ion conductor 132, which may be a sintered body of particles. In the air electrode 130, the electronic conductor 131 may include a lanthanum strontium manganite (LSM) based material, a lanthanum strontium cobalt (LSC) based material, a lanthanum strontium cobalt manganese (LSCM) based material, a lanthanum strontium cobalt ferrite (LSCF) based material, a lanthanum strontium ferrite (LSF) based material, a barium strontium cobalt iron (BSCF) based material, or a samadium strontium cobalt (SSC) based material. The ion conductor 132 may include an yttria stabilized zirconia (YSZ) based material, a ceria (CeO₂) based material, a bismuth oxide (Bi₂O₃) based material, or a lanthanum gallate (LaGaO₃) based material. Furthermore, the air electrode 130 may be a porous body including pores H3, and gas, fluid, and the like, may enter and exit through the pores H3.

To explain a dam structure of the electrolyte 120 in more detail, as described above, the electrolyte 120 includes the base portion 121, the dam portion 122, and the recess portion 123. The recess portion 123 is surrounded by the dam portion 122. That is, the recess portion 123 may be defined by the dam portion 122. However, in FIG. 1, the dam portion 122 is blocked in all directions, and accordingly, the recess portion 123 is not connected to the outside in a lateral direction, which is not essential. That is, the dam portion 122 may include some discontinuous regions, and accordingly, the recess portion 123 may be opened through the discontinuous region of the dam portion 122 in the lateral direction. The air electrode 130 may be disposed in the recess portion 123 of the electrolyte 120, and in the instant case, the air electrode 130 may be spaced apart from the dam portion 122 and disposed not to come into contact with the dam portion 122. In a case in which the air electrode 130 is not in contact with and is spaced apart from the dam 122, when pressure is exerted on the solid oxide cell 100, the pressure may not be concentrated on the air electrode 130 and may be effectively dispersed toward the electrolyte 120. Furthermore, when the solid oxide cell 100 is implemented in a stack structure, a gap between interconnects and the solid oxide cell 100 may be reduced, and a contact region between the sealing material and the solid oxide cell 100 may increase to improve airtightness thereof.

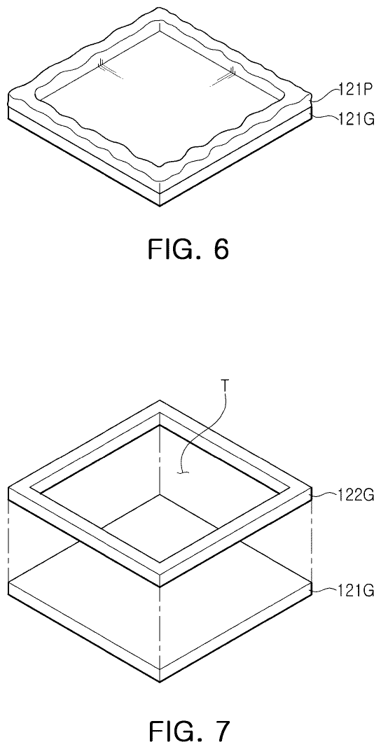

The dam portion 122 may be disposed on edge of the base portion 121 and may have an integral structure with the base portion 121. Here, the integrated structure may denote a form in which the base portion 121 and the dam portion 122 are sintered together rather than separately manufactured and attached. In the integrated structure, a separate bonding layer may not be provided between the base portion 121 and the dam portion 122. In the case of a specific method of forming the dam portion 122, first, a method of applying and sintering a paste 121P for the dam portion along an edge of a green sheet 121G for the base portion may be used in the structure illustrated in FIG. 6. As another example, as illustrated in FIG. 7, a method of stacking a plurality of green sheets 121G and 122G may be used. In other words, the method corresponds to a method of forming a through-hole T in the green sheet 122G for the dam portion, stacking the green sheet 122G on the green sheet 121G for the base portion, and then sintering the green sheets 121G and 122G.

In the electrolyte 120, the base portion 121 and the dam portion 122 may include the same material, but may include different materials in consideration of each function of the base portion 121 and the dam portion 122. Specifically, the base portion 121 may include an ion conductor, such as 8YSZ, which is widely used as a material for the electrolyte 120, and the dam portion 122 may include 3YSZ having a better strength than the 8YSZ, to enhance an effect such as improvement of durability. Furthermore, as another example, the base portion 121 may include a YSZ-based ion conductor, and the dam portion 122 may include alumina (Al₂O₃). When the dam portion 122 includes alumina (Al₂O₃), the strength of the dam portion 122 may be excellent to improve durability of the solid oxide cell 100.

Meanwhile, as illustrated in FIG. 2, the fuel electrode 110 and the air electrode 130 may have substantially the same width, and the solid oxide cell 100 may be implemented in a supporting structure of the electrolyte 120. Here, the width of the fuel electrode 110 and the air electrode 130 may be measured in a direction perpendicular to a thickness direction (Z-direction) of the electrolyte 120, and more specifically, the width thereof may be a width measured in a Z-Y cross-section disposed in a center of the solid oxide cell 100. In the instant case, in order to increase the precision of width measurement, the Z-Y cross-section may be further taken in other regions in addition to the center thereof, and an average value of a plurality of width values may be used.

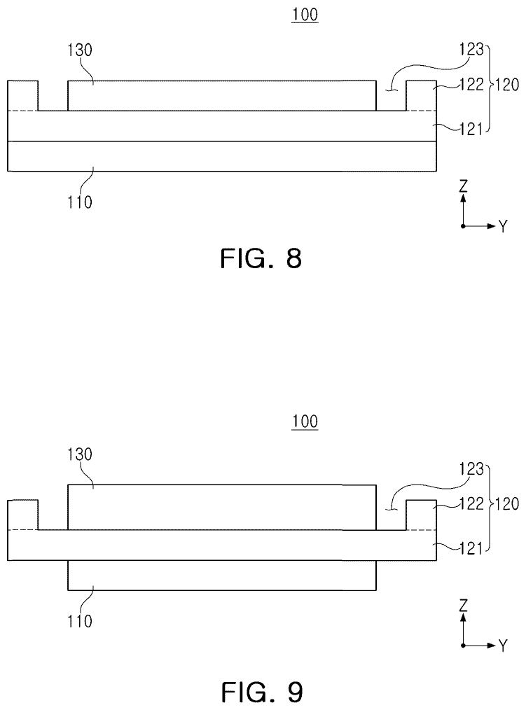

A form in which a relative width of the fuel electrode 110 increases compared to the example embodiment of FIG. 2 may also be adopted. That is, as in a modified example of FIG. 8, the fuel electrode 110 may be wider than the air electrode 130, and furthermore, the width of the fuel electrode 110 may be substantially equal to that of the electrolyte 130. When the width of the fuel electrode 110 is expanded in this manner, the solid oxide cell 100 may be implemented in a supporting structure of the fuel electrode 110. Furthermore, in FIG. 2, thicknesses of the dam portion 122 and the air electrode 130 are substantially identical to each other, but relative thickness conditions of the dam portion 122 and the air electrode 130 may be changed to obtain an intended effect. For example, as in a modified example of FIG. 9, a thickness of the dam portion 122 may be smaller than that of the air electrode 130, and the thickness of the air electrode 130 may be sufficiently ensured to improve the reaction efficiency of the solid oxide cell 100.

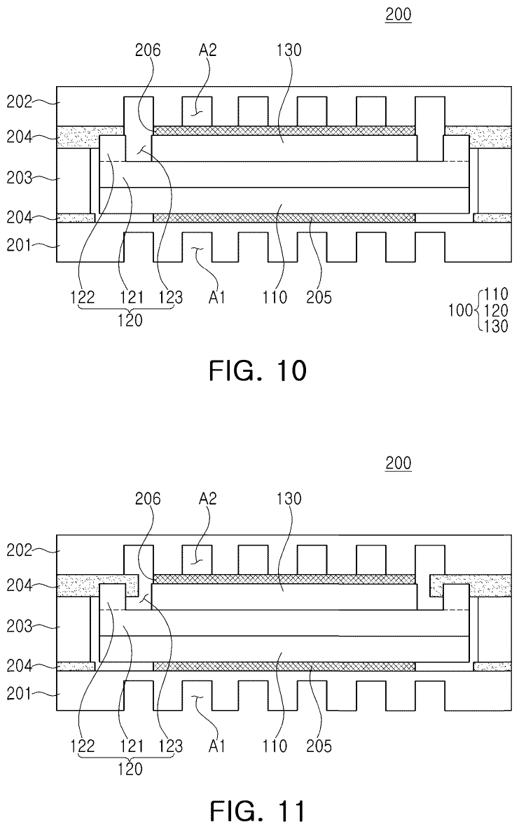

Hereinafter, a solid oxide cell stack 200 including the solid oxide cell 100 will be described. Referring to FIG. 10, the solid oxide cell stack 200 includes first and second interconnects 201 and 202, and the solid oxide cell 100 with the aforementioned structure are disposed between the first and second interconnects 201 and 202. That is, the solid oxide cell 100 includes a fuel electrode 110, an electrolyte 120, and an air electrode 130, where the electrolyte 120 includes a base portion 121, a dam portion 122, and a recess portion 123. Furthermore, a region in which the fuel electrode 110 and the electrolyte 120 overlap each other in a thickness direction of the electrolyte 120 is greater than or equal to a region in which the air electrode 130 and the electrolyte 120 overlap each other.

The first and second interconnects 201 and 202 may be electrically connected to the solid oxide cell 100, and, for example, when the solid oxide cell stack 200 includes a stacked structure of a plurality of solid oxide cells 100, the first and second interconnects 201 and 202 may be disposed between adjacent solid oxide cells 100 and may connect the solid oxide cells 100. The first and second interconnects 201 and 202 may have a flat plate structure and may include flow paths A1 and A2 through which gas may be diffused. The first and second interconnects 201 and 202 may include a material having excellent electrical conductivity and low degradation in a high-temperature environment. As a specific example, the first and second interconnects 201 and 202 may include a metal including stainless steel, nickel, iron, and copper. Furthermore, a first current collector 205 may be disposed between the first interconnect 201 and the fuel electrode 110, and a second current collector 206 may be disposed between the second interconnect 202 and the air electrode 130.

As illustrated in FIGS. 10 and 11, the solid oxide cell stack 200 may include a sealing material 204 disposed between the first and second interconnects 201 and 202 to connect the first and second interconnects 201 and 202. Here, the sealing material 204 may include a glass-based material, and in the instant case, a tissue thereof becomes dense at high temperatures to prevent liquid or gas from leaking. Furthermore, as an additional sealing structure, the solid oxide cell stack 200 may further include a structure such as a gasket 203 disposed between the first and second interconnects 201 and 202, in which case the sealing material 204 may be disposed between the first interconnect 201 and the gasket 203, and between the second interconnect 202 and the gasket 203. The sealing material 204 may be in contact with the dam portion 122, and specifically, the sealing material 204 may be in contact with an upper surface and an external surface of the dam portion 120. By adopting the dam portion 122, a contact region between the sealing material 204 and the solid oxide cell 100 may increase as compared to the conventional technology, thereby improving the durability and airtightness of the solid oxide cell stack 200. Furthermore, a contact region between the sealing material 204 and the dam portion 122 may be further expanded, and as illustrated in FIG. 11, the sealing material 204 may be in contact with an upper surface, an external side surface and an internal side surface of the dam portion 122. A contact region between the sealing material 204 and the electrolyte 120 may be sufficiently secured, while the air electrode 130 may be spaced apart from the sealing material 204. From this structure, when assembling or driving the solid oxide cell stack 200, external influences such as stress exerted on the air electrode 130 may be reduced to minimize performance degradation of the air electrode 130.

The present disclosure is not limited to the above-described example embodiments and the accompanying drawings but is defined by the appended claims. Therefore, those of ordinary skill in the art may make various replacements, modifications, or changes without departing from the scope of the present disclosure defined by the appended claims, and these replacements, modifications, or changes should be construed as being included in the scope of the present disclosure.

What is claimed is:

1. A solid oxide cell comprising:
a fuel electrode;
an electrolyte including a base portion disposed on the fuel electrode, a dam portion disposed on edge of the base portion, and a recess portion surrounded by the dam portion; and
an air electrode disposed in the recess portion of the electrolyte,
wherein a region in which the fuel electrode and the electrolyte overlap each other in a thickness direction of the electrolyte is greater than or equal to a region in which the air electrode and the electrolyte overlap each other.

2. The solid oxide cell according to claim 1, wherein the air electrode is spaced apart from the dam portion.

3. The solid oxide cell according to claim 1, wherein the base portion and the dam portion are integrated.

4. The solid oxide cell according to claim 1, wherein the base portion and the dam portion include different materials.

5. The solid oxide cell according to claim 4, wherein the base portion includes 8 mol % yttria-stabilized zirconia (8YSZ), and the dam portion includes 3 mol % yttria-stabilized zirconia (3YSZ).

6. The solid oxide cell according to claim 4, wherein the base portion includes a Yttria Stabilized Zirconia-based (YSZ-based) ion conductor, and the dam portion includes alumina.

7. The solid oxide cell according to claim 1, wherein the fuel electrode and the air electrode have substantially the same width.

8. The solid oxide cell according to claim 1, wherein the fuel electrode is wider than the air electrode.

9. The solid oxide cell according to claim 1, wherein the fuel electrode and the electrolyte have substantially the same width.

10. The solid oxide cell according to claim 1, wherein a thickness of the dam portion is less than or equal to a thickness of the air electrode.

11. A solid oxide cell stack comprising:
first and second interconnects; and
a solid oxide cell disposed between the first and second interconnects,
wherein the solid oxide cell comprises:
a fuel electrode;
an electrolyte including a base portion disposed on the fuel electrode, a dam portion disposed on the base portion, and a recess portion surrounded by the dam portion; and
an air electrode disposed in the recess portion of the electrolyte,
wherein a region in which the fuel electrode and the electrolyte overlap each other in a thickness direction of the electrolyte is greater than or equal to a region in which the air electrode and the electrolyte overlap each other.

12. The solid oxide cell stack according to claim 11, further comprising:
a sealing material disposed outside of the solid oxide cell between the first and second interconnects.

13. The solid oxide cell stack according to claim 12, wherein the sealing material is in contact with the dam portion.

14. The solid oxide cell stack according to claim 13, wherein the sealing material is in contact with an upper surface and an external side surface of the dam portion.

15. The solid oxide cell stack according to claim 14, wherein the sealing material is in contact with the upper surface, the external side surface, and an internal side surface of the dam portion.

16. The solid oxide cell stack according to claim 12, wherein the air electrode is spaced apart from the sealing material.

17. The solid oxide cell stack according to claim 11, wherein each of the first and second interconnects includes a flow path through which gas is diffused.
